(19) United States
(12) Patent Application Publication
(10) Pub. No.: US 2010/0007675 A1
(43) Pub. Date: Jan. 14, 2010

(54) METHOD AND APPARATUS FOR EDITING IMAGE USING TOUCH INTERFACE FOR MOBILE DEVICE

(76) Inventors: Seong-hoon KANG, Suwon-si (KR); Se-hoo Kim, Seongnam-si (KR)

Correspondence Address: North Star Intellectual Property Law, PC, P.O. Box 34688, Washington DC, DC, 20043, US

(21) Appl. No.: 12/497,568

(22) Filed: Jul. 3, 2009

(30) Foreign Application Priority Data
Jul. 8, 2008 (KR) 10-2008-0066145

(51) Int. Cl. G09G 5/02; G06T 11/20

(52) U.S. Cl. 345/592; 345/442; 345/173

(57) ABSTRACT

A mobile device and method of editing an image in the mobile device are disclosed. The method of editing an image includes dividing the image into an uncertain region, an object region, and a background region along the boundary line which is input through a touch interface and displayed on the image, determining a last object region by determining the uncertain region as one of the object region and the background region through color comparison of the uncertain region with neighboring blocks, and post-correcting an error included in the last object region.

### CROSS-REFERENCE TO RELATED APPLICATION(S)

This application claims the benefit under 35 U.S.C. § 119(a) of a Korean Patent Application No. 10-2008-0066145, filed on Jul. 8, 2008, the disclosure of which is incorporated herein in its entirety by reference.

### BACKGROUND

1. Field

The following description relates to a method and apparatus for editing an image in a mobile device, and more particularly, to a method and apparatus for inputting a boundary line of an object region using a touch interface, determining the object region, and post-correcting the determined region.

2. Description of the Related Art

Conventional mobile devices have become multi-functional and include functions to download a variety of contents over the Internet, shoot moving pictures using a camera function, and append and transmit image data to a message using a multimedia message service (MMS).

Users of the multi-functional mobile devices may prefer user-specific media editing and production tools due to proliferation of user created contents (UCC). Parody and image composition have become particularly popular.

Also, due to an increase in use and production of touch devices, a wide variety of touch devices are commercially available. Particularly, finger-operable touch interfaces have been widely applied to mobile devices.

Accordingly, it may be desirable to include an image editing and compositing interface that may be easily used on a touch device.

In a conventional technique, a user may input an initial boundary with relative precision by finely adjusting a control pointer to directly determine a boundary at an input location. However, this conventional technique may be difficult to apply to a touch interface.

Also, since an object region may be determined with reference to a contour line in a motion direction in a position where a user inputs a start point, it may be desirable for a boundary of the object region to be clear.

Further, since the technique involves a user inputting contour information using a mouse or direction keys, checking pixels around the contour, and comparing color values of neighboring pixels in order to determine a last object region, erroneous results may be obtained which are not easily post-corrected.

### SUMMARY

In one general aspect, there is provided a method of editing an image in a mobile device, the method including dividing the image into an uncertain region, an object region, and a background region along a boundary line which is input through a touch interface and displayed on the image, and determining a last object region by determining the uncertain region as one of the object region and the background region through color comparison of the uncertain region with neighboring blocks.

The dividing of the image may include displaying the boundary line using a translucent looped curve having a predetermined thickness.

The dividing of the image may include masking a transparency adjustment channel on the image to display the uncertain region as a translucent region, the object region as a transparent region, and the background region as an opaque region.

The determining of the last object region may include segmenting the image into unit blocks having significantly identical colors, and searching to find the uncertain region of the image, and sequentially searching to find neighboring blocks in eight directions of the uncertain region, and determining a state of the uncertain region by comparing a color of the neighboring block with a color of the uncertain region.

The method may further include after the determining of the last object region, post-correcting an error included in the last object region.

The post-correcting of the error may include adding or deleting a block selected through the touch interface to or from the object region.

The method may further include editing the last object region by compositing the last object region with another image.

In another general aspect, there is provided an apparatus to edit an image in a mobile device, the apparatus including a touch screen to sense a boundary line input to an image through a touch interface and to display the boundary line, and a controller to divide the image into an uncertain region, an object region, and a background region along the boundary line and to determine a last object region by determining the uncertain region as one of the object region and the background region through color comparison of the uncertain region with neighboring blocks.

The touch screen may further include a touch sensing unit to adjust a sensitivity of the touch interface to input the boundary line, and a display unit to display the boundary line using a translucent looped curve having a predetermined thickness.

The controller may mask a transparency adjustment channel on the image to display the uncertain region as a translucent region, the object region as a transparent region, and the background region as an opaque region.

The controller may segment the image into unit blocks having significantly identical colors, and may search to find the uncertain region of the image.

The controller may sequentially search to find neighboring blocks in eight directions of the uncertain region, and may determine a state of the uncertain region by comparing a color of the neighboring block with a color of the uncertain region.

The controller may post-correct an error included in the last object region.

The controller may add or delete a block selected through the touch interface to or from the object region.

The controller may edit the last object region by compositing the last object region with another image.

Other features and aspects will be apparent from the following detailed description, the drawings, and the claims.

### BRIEF DESCRIPTION OF THE DRAWINGS

FIG. 1 is a block diagram illustrating an exemplary mobile device.

FIG. 2 is a flowchart illustrating an exemplary process of editing an image.

FIG. 3 is a diagram of a screen example to explain exemplary touch input information.

FIG. 4 is a diagram illustrating an exemplary boundary line input to an image.

FIG. 5 is a diagram of a screen example to explain an exemplary process of masking a transparency adjustment channel on an image.

FIGS. 6A through 6F are diagrams of screen examples to explain an exemplary process of editing an image.

FIG. 7 is a flowchart illustrating an exemplary process of inputting a boundary line to an image.

FIG. 8 is a flowchart illustrating an exemplary process of determining a last object region.

FIGS. 9A through 9F are diagrams of screen examples to explain an exemplary process of determining a last object region.

FIG. 10 is a flowchart illustrating an exemplary process of post-correcting a last object region.

FIGS. 11A through 11C are diagrams of screen examples to explain an exemplary process of post-correcting a last object region.

FIGS. 12A through 12C are diagrams of screen examples in which exemplary image editing and composition are applied.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

In the example(s) described herein, a “boundary line” indicates a line having a certain thickness input to an image through a touch interface in order to divide an object region. In this case, the thickness of the boundary line is indicated in consideration of previously stored touch sensitivity and a line width. A “looped curve” indicates one continuous curve so that a region internal to the boundary line displayed on an image through the touch interface may be determined as an object region. A “transparency adjustment channel” is a channel to adjust transparency of an image, and exhibits an effect where overlapping with an image. That is, where the transparency adjustment channel is masked on the image, an object region is transparently represented, a background region is opaquely represented, and an uncertain region is translucently represented. A “masking” indicates a process in which the channel overlaps with an image to distinguish an object region, an uncertain region and a background region by assigning a transparency value of the corresponding transparency adjustment channel to the image. An “object region” indicates a region obtained by masking the transparency adjustment channel on a region internal to the boundary line displayed on the image through the touch interface or on an image in which the boundary line is displayed. An “uncertain region” indicates a translucent region not determined as any one of an object region and a background region on an image. That is, the uncertain region indicates a width of a boundary line input through the touch interface. A “background region” indicates an opaque region outside of the object region and the uncertain region in the image. A “block” indicates a unit to segment an image into similar color regions in the image using colors of the regions.

An exemplary mobile device consistent with the teachings herein may edit an image using a touch interface. The mobile device may be a mobile phone, a personal digital assistant (PDA), a code division multiple access (CDMA) terminal, a wideband code division multiple access (WCDMA) terminal, a global system to perform mobile communication (GSM) terminal, an international mobile telecommunication 2000 (IMT-2000) terminal, a smart phone terminal, a universal mobile telecommunication system (UMTS) terminal, a notebook computer, a personal computer, and the like.

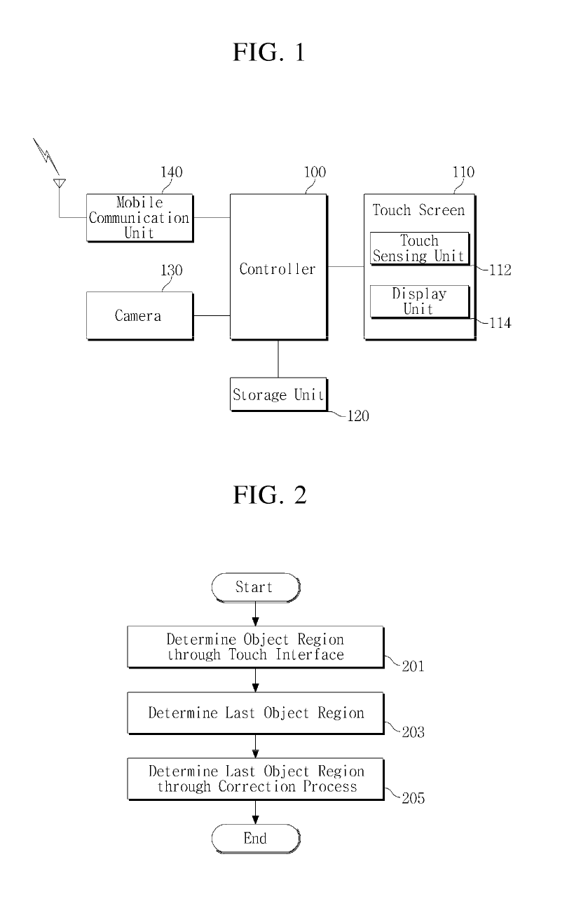

FIG. 1 illustrates an exemplary mobile device.

Referring to FIG. 1, the mobile device includes a controller 100, a touch screen 110, a storage unit 120, a camera 130, and a mobile communication unit 140. The touch screen 110 includes a touch sensing unit 112 and a display unit 114.

In the touch screen 110, the touch sensing unit 112 may include a touch sensor (not illustrated) and a signal converter (not illustrated). In response to a touch occurring, the touch sensor detects a change of a physical quantity, e.g., resistance or capacitance corresponding to the touch, and senses that the touch has occurred. The signal converter converts the change of the physical quantity into a touch signal. Particularly, the touch sensing unit 112 senses an input of a boundary line to determine an object region in an image from a user or an input of an error region to post-correct an error included in a last object region from a user. In response to the user moving his or her finger while keeping contact with the touch screen 110, the touch sensing unit 112 continuously senses a touch input while moving according to a touch region. Here, the touch region may be a specific region corresponding to a finger width defined by the user in advance. In this case, the specific region indicates a region of the touch sensing unit 112 touched by a tip of the user's finger. Where movement of the touch region is sensed, the touch sensing unit 112 transmits a coordinate from a touch start point to a touch end point to the controller 100 under control of the controller 100. In addition, the touch sensing unit 112 serves as an input unit corresponding to a conventional mobile device.

The display unit 114 displays various information related to a state and operation of the mobile device. The display unit 114 may be implemented as a liquid crystal display (LCD) and a touch panel disposed on the LCD. The display unit 114 includes an LCD controller and an LCD display device. Particularly, the display unit 114 displays a boundary line input through a touch interface on the image under control of the controller 100.

The storage unit 120 stores application programs necessary to perform functional operation according to an exemplary embodiment, as well as blocks in an uncertain state for determining a state of uncertain blocks through color comparison with neighboring blocks. The storage unit 120 includes a program area and a data area. The program area stores an operating system (OS) to boot the mobile device, and a transparency adjustment channel masked on an image to display the input boundary line on the image. The program area also stores an application program to segment an image into unit blocks having similar colors. The program area also stores an application program to discover uncertain blocks and neighboring blocks on the image and determine a state of the uncertain blocks through color comparison. The program area also stores an application program to clearly represent an unclear boundary of a last post-corrected object region where an error of an object region is post-corrected. The data area stores data generated where the mobile device is used, including uncertain blocks to determine a state of the blocks through color comparison with the neighboring blocks, image files photographed by the camera 130, previously stored image files, received image files and video files, etc.

The camera 130 may include a camera sensor (not illustrated) to photograph a subject and convert an obtained optical signal into an electrical signal under control of the controller 100, and a signal processor (not illustrated) to convert an analog image signal from the camera sensor into digital data. For example, the camera sensor may be a charge coupled device (CCD) sensor. The signal processor may be implemented as, for example, a digital signal processor (DSP). The camera 130 photographs a subject and obtains image data to perform image editing.

The mobile communication unit 140 establishes a communication channel with a base station to recognize location information of the mobile device, and transmits and receives necessary signals. The mobile communication unit 140 includes a radio frequency (RF) transmitter to up-convert and amplify a frequency of a transmitted signal, and an RF receiver to low-noise amplify a received signal and down-convert a frequency of the signal. Also, the mobile communication unit 140 transmits edited image data to another mobile device corresponding to the other mobile device to composite the image, or receives necessary image data from the other mobile device in order to edit the image.

The controller 100 controls operations of the mobile device and a signal flow among the internal blocks. Also, the controller 100 senses a boundary line appearing on the image due to the touch of the user's finger, through the touch sensing unit 112. Here, the controller 100 may adjust a thickness of an input line and touch sensitivity in input information from the touch sensing unit 112 to input the boundary line to the image. For example, the line thickness may be defined and set as a width at which a user's finger tip is in contact with the touch sensing unit 112. In this case, the touch sensing unit 112 senses a finger-touched portion in the previously set width as the touch input, and continuously senses the touch input while moving along the touch region where the user moves the finger in a contact state. That is, the controller 100 recognizes the region continuously sensed by the touch sensing unit 112 as the boundary line to determine the object region on the image.

The controller 100 masks an object region, an uncertain region and a background region using a value on the transparency adjustment channel in the image on which the boundary line input through the touch interface is displayed. Here, the transparency adjustment channel is set in addition to a basic channel of the image in order to more conveniently and effectively perform an image processing task. The transparency adjustment channel includes a channel which is not one of three channels used where an image is in a three-primary color (red-green-blue; RGB) mode, among a total of four 8-bit channels in a 32-bit image system. In this case, the transparency adjustment channel allows effective combination of two colors of an image where a color of one pixel overlaps with a color of another pixel. For example, if the transparency adjustment channel, which exhibits an effect where overlapping with the image, is masked on the image, an object region (0xFF) is transparently represented, a background region (0x00) is opaquely represented, and an uncertain region (0x80) is translucently represented. That is, the object region (0xFF), an internal region, is transparently represented, the background region (0x00), an external region, is opaquely represented, and the uncertain region (0x80) is translucently represented with reference to the boundary line input by the user touch interface.

The controller 100 segments the image into blocks having similar colors in the divided regions of the image. Here, the application program to segment the image into the similar color regions includes an image segmentation algorithm, which is a region-based method using color similarity in a given image. In this case, the region-based method uses similarity between pixels of an image, and is useful where a technique corresponding to a detailed boundary portion of an object in a noisy environment is not essential. For example, the controller 100 may utilize a watershed method as the application program to segment an image into blocks having similar colors in the image.

The controller 100 horizontally searches to find blocks in an uncertain state in the image. Here, the controller 100 stores, in the storage unit 120, the uncertain blocks, which are objects that are too unclear to be determined as the object region or the background region searched from the image. In response to the uncertain blocks being searched, the controller 100 performs color comparison with neighboring blocks using the searched uncertain block as a starting block.

The controller 100 determines the uncertain block stored in the storage unit 120 as the object region or the background region by comparing a color of the uncertain block with a color of the neighboring block. To perform color comparison, the controller 100 sequentially discovers neighboring blocks in eight directions (east (E), west (W), south (S), north (N), northeast (NE), southeast (SE), southwest (SW) and northwest (NW)) and checks a region state of the blocks. Meanwhile, where the neighboring blocks are all in an uncertain region state, the controller 100 may not determine a state of the current uncertain block through color comparison with the neighboring blocks and accordingly, moves to a next neighboring block and determines the state of the block.

The controller 100 determines whether there is an object region block or a background region block as a neighboring block of the uncertain block in order to compare a color between the uncertain block and the neighboring block. Here, the controller 100 calculates a distance between block colors, and determines the region of the uncertain block to be the same as the closest block to compare the color between the uncertain block and the neighboring block. For example, the controller 100 may use a Gaussian color model method as an application program to perform a comparison between colors of the blocks.

The controller 100 determines the object region of the image based on the region state of each block determined through the color comparison with the neighboring block. The controller 100 adds the transparency adjustment channel including the stored masking information to the original image in order to determine a last object region.

Where there is an error in the last object region, the controller 100 determines a complete object region through a post-correction process of adding or deleting the last object region. Here, the controller 100 corrects the last object region by adding the segmented blocks having similar colors to the object region or deleting them from the background region.

The controller 100 selects a state of the corrected region to correct the last object region in which errors are included. Here, the state of the corrected region is determined as one of the object region and the background region by the user input. For example, where an input to select the corrected region as the object region is sensed, the controller 100 determines a state of the erroneous region input through the touch interface, to be the object region. On the other hand, where an input to select the corrected region as a background region is sensed, the controller 100 determines the state of the error region input through the touch interface, as the background region. In this case, the controller 100 senses the input to select the corrected region by recognizing a motion of the finger tip through the touch sensing unit 112 in the last object region in which errors are included.

Meanwhile, the controller 100 may use a pixel-based correction method to correct a detailed portion of the object region. In this disclosure, a method to correct a region to be corrected, on a block-by-block basis, through the touch interface is used.

Where a boundary of the last corrected object region of the image is unclear, the controller 100 represents the boundary as a clear curve through the application program. Here, where a desired object region is designated, the controller 100 clearly composites the designated region. For example, the controller 100 may use a Poisson image editing scheme as an application program to clearly represent the unclear boundary. With the Poisson image editing scheme, a Poisson equation is applied to achieve an excellent composition effect, such as a clear joint between an original image and an object image and clear connection of discontinuous boundary lines.

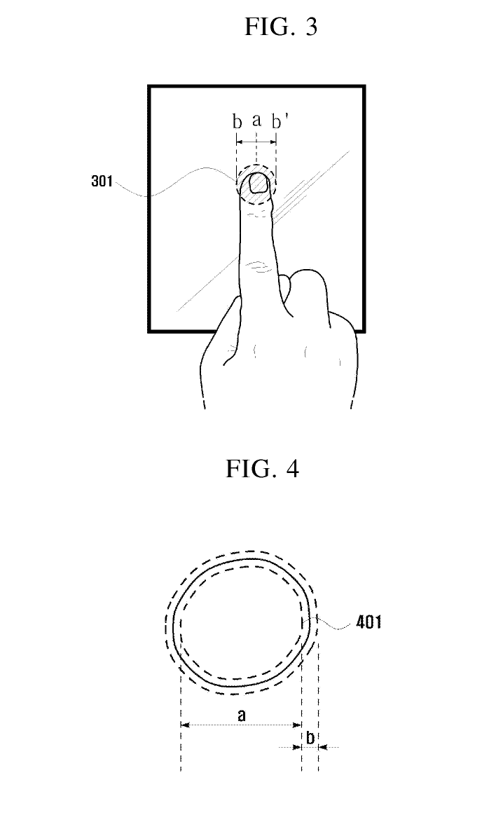

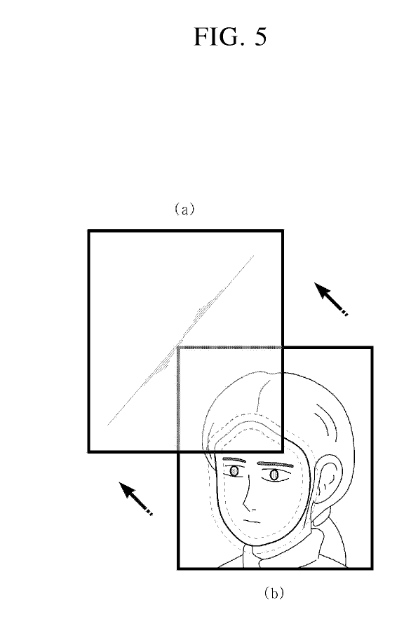

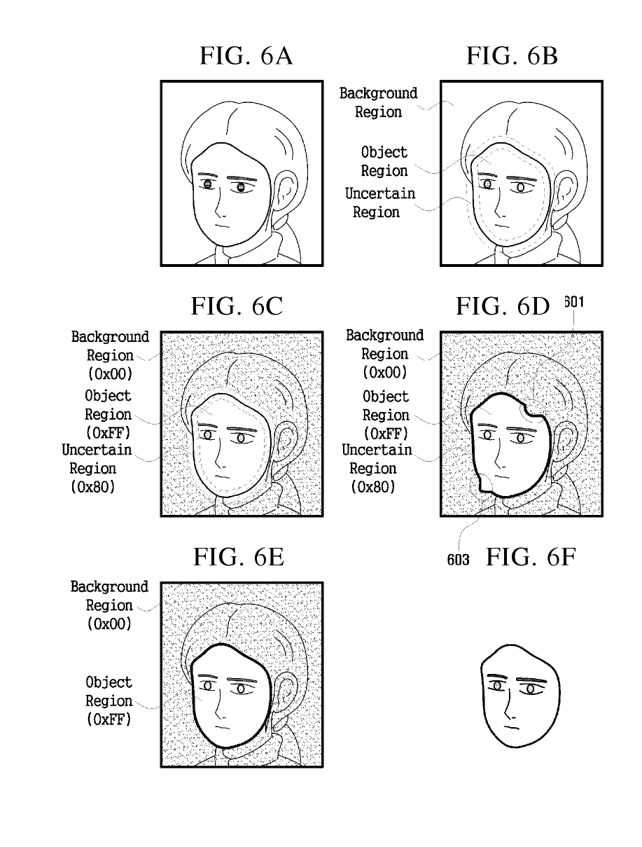

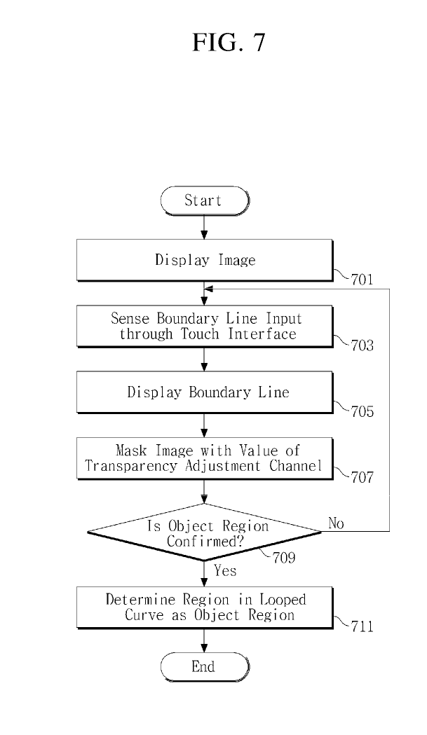

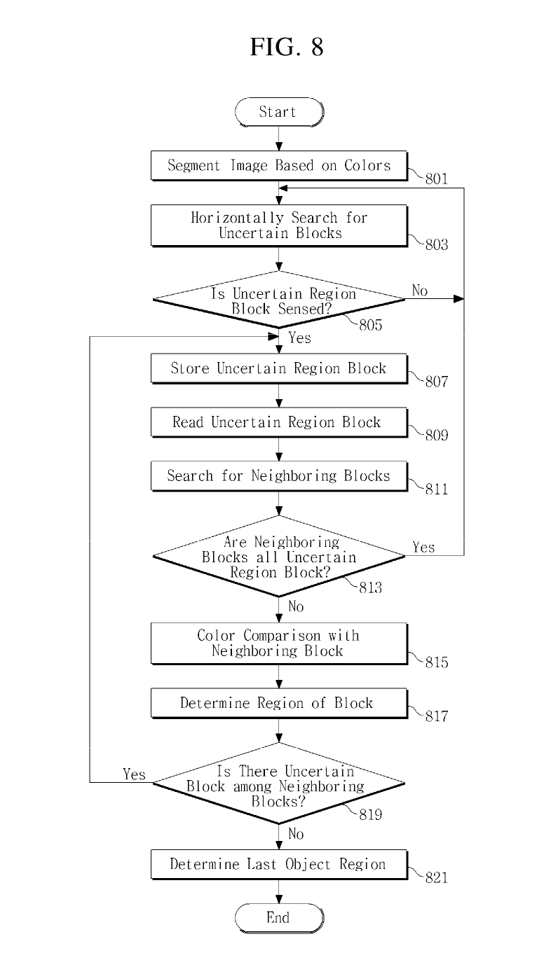

FIG. 2 illustrates an exemplary process of editing an image, FIG. 3 illustrates a screen example to explain touch input information, FIG. 4 illustrates a screen example to explain a boundary line input to an image, FIG. 5 illustrates a screen example to explain an exemplary process of masking a transparency adjustment channel on an image, and FIGS. 6A through 6F illustrate screen examples to explain the exemplary process of editing an image.

Referring to FIG. 2 through 6F, the controller 100 senses an input of a boundary line in an image through the touch interface as illustrated in FIG. 6A (operation 201). For example, where the input line is sensed through the touch interface, the controller 100 controls the touch screen 110 to display the sensed input line on the display unit 114, as illustrated in FIG. 6B. Here, the controller 100 divides the image into an object region, an uncertain region and a background region where the image is touched with a finger tip. In this case, the controller 100 senses the boundary line using touch input information of the touch interface. For example, as illustrated in FIG. 3, the controller 100 senses a finger-touched center line a as the touch input information and senses a line b-b′ indicated with reference to the center line a, as a touch input region. In this case, the controller 100 defines a finger-tip touched region 301 between b and b′ of the touch screen 110, as a touch width determined in advance by the user. Here, since the line thickness may be differently sensed depending on a size and a shape of the user's finger tip, the touch sensing unit 112 senses a touch line according to a predefined width. That is, the touch sensing unit 112 senses the finger-tip touched region 301 as the touch region. Accordingly, the controller 100 recognizes the touch input information, such as the thickness of the line input through the touch interface, and touch sensitivity adjustment.

The controller 100 determines the object region internal to the looped curve input through the touch interface as a rough object region. For example, as illustrated in FIG. 4, the controller 100 recognizes lines input to the image through the touch interface, i.e., lines having a width indicated by reference numeral ‘b’ as boundary lines, and determines a region between the lines as the uncertain region of the image. The controller 100 recognizes a region internal to the looped curve input through the touch interface, i.e., a region having a width indicated by reference numeral ‘a’, as the object region. The controller 100 determines a region external to the boundary line not included in the uncertain region and the object region in the image, as the background region. In this case, the controller 100 recognizes the internal line 401 among the boundary lines input through the touch interface as the looped curve.

Where the input of the boundary line is sensed through the touch interface, the controller 100 masks the transparency adjustment channel on the image to which the boundary line is input. As illustrated in FIG. 5, the controller 100 assigns a transparency value on the transparency adjustment channel of the image to the object region, the uncertain region and the background region. Here, the transparency adjustment channel (a) exhibits an effect where overlapping with the image (b). That is, where the image is masked with the transparency adjustment channel, the controller 100 creates an image masked with an object region (0xFF), an uncertain region (0x80) and a background region (see FIG. 6C). Here, the controller 100 controls to display the object region (0xFF) transparently, the background region (0x00) opaquely, and the uncertain region (0x80) translucently on the display unit 114. In this case, the transparency adjustment channel is set in addition to a basic channel to more conveniently and effectively edit the image. The transparency adjustment channel is one channel outside of three channels used where an image is in a three-primary color (red-green-blue; RGB) mode, among a total of four 8-bit channels in a 32-bit image system. The transparency adjustment channel allows effective combination of two colors of an image where a color of one pixel overlaps with a color of another pixel.

The controller 100 segments the image into blocks having similar colors in order to determine the uncertain block as the object region or the background region in the image (operation 203). The controller 100 sequentially searches for the uncertain blocks through horizontal search of image blocks. The controller 100 performs color comparison with the neighboring blocks using the searched uncertain block as a starting block. That is, the controller 100 searches to find neighboring blocks in eight directions to determine a state of the uncertain block. Where the object region or the background region is in the neighboring blocks, the controller 100 determines a state of the current uncertain block through color comparison with the blocks. Here, the color comparison is performed by calculating a distance between colors and determining a state of the block to be the same as the closest block. The controller 100 composites the transparency channel including masking information corresponding to the determined object region with an original image to determine a last object region. For example, the controller 100 controls to display the last object region on the display unit 114 of the touch screen 110, as illustrated in FIG. 6D. Here, the controller 100 recognizes from a user input signal that errors 601 and 603 are included in the last object region. That is, where the errors in the last object region are sensed by the user touch interface, the controller 100 determines the last corrected object region through a post-correction process performed on the selected region.

The controller 100 performs the post-correction process on the errors included in the last object region (operation 205). That is, where errors exist in the last object region, the controller 100 determines the last corrected object region through the post-correction process to add or delete the object region. Here, the controller 100 performs the correction by adding or deleting the last object region in units of blocks having similar colors.

The controller 100 determines a state of the corrected region to correct the last object region including errors. Here, the state of the corrected region is divided into the object region or the background region determined by the user input. For example, where an input to select the corrected region as the object region is sensed, the controller 100 determines the state of the error region input through the touch interface, as the object region. On the other hand, where an input to select the corrected region as the background region is sensed, the controller 100 determines the state of the error region input through the touch interface, as the background region. In this case, the controller 100 senses the input to select the corrected region by recognizing a motion of the finger tip through the touch sensing unit 112 in the last object region in which errors are included. For example, the controller 100 corrects the errors 601 and 603 of the object region and controls to display the last corrected object region on the display unit 114 of the touch screen 110, as illustrated in FIG. 6E.

As illustrated in FIG. 6F, the controller 100 performs an error post-correction process and stores the last corrected object region in the storage unit 120. The controller 100 may also edit or composite the last corrected object region in or with another image.

As described above, the exemplary method of editing an image using a touch interface includes inputting the rough boundary line to determine the object region in the image, determining the last object region, and post-correcting the last object region. The processes will now be described further with reference to the drawings.

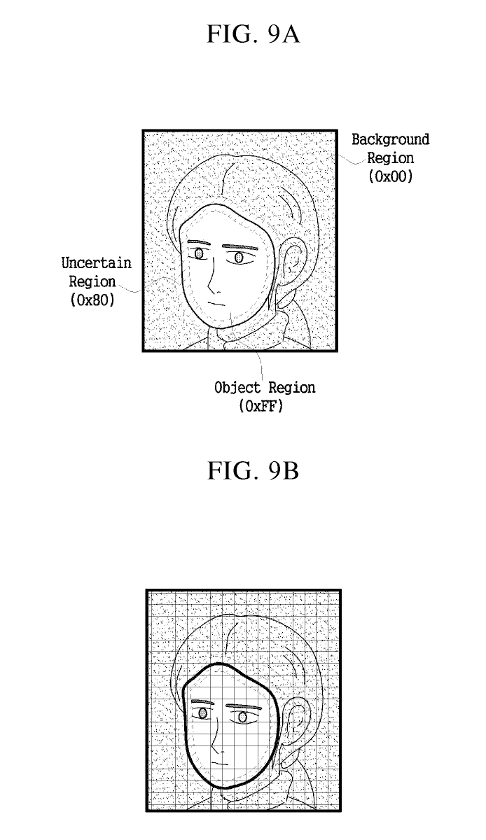

FIG. 7 illustrates an exemplary process of inputting a boundary line to an image.

Referring to FIGS. 3 through 7, the controller 100 determines an object region, reads one image stored corresponding to image editing and composition from the storage unit 120, and controls the touch screen 110 to display the image on the display unit 114 (operation 701).

The controller 100 senses the boundary line input to determine the object region in the image through the touch interface (operation 703). Here, the controller 100 stores information such as a thickness of the line input through the touch interface and touch sensitivity adjustment, in the storage unit 120 in advance. In this case, the controller 100 senses only the touch of the finger tip to input a looped curve to determine a desired object region in the image. That is, the touch sensing unit 112 senses the finger-touched region 401 as a touch region. For example, as illustrated in FIG. 3, the controller 100 senses the finger-touched center line a from the touch sensing unit 112 as the touch input information, and senses the line b-b′ indicated with reference to the center line a, as the touch input region. In this case, the controller 100 defines a finger-tip touched region 301 between b and b′ of the touch screen 110, as a touch width determined in advance by the user. Here, since the thickness may be differently sensed depending on a size and shape of the user's finger, the touch sensing unit 112 senses a touch line according to a predefined width. That is, the touch sensing unit 112 senses the finger-tip touched region 301 as the touch region.

Where the input of the boundary line is sensed through the touch interface, the controller 100 controls to display the input boundary line on the display unit 114 (operation 705).

The controller 100 assigns a transparency value on the transparency adjustment channel to the image to determine an object region (operation 707). Here, the transparency adjustment channel exhibits an effect where overlapping with the image. Where the image is masked with the transparency adjustment channel, the controller 100 controls to represent the object region (0xFF) transparently, the background region (0x00) opaquely, and the uncertain region (0x80) translucently on the display unit 114. In this case, the controller 100 determines a region internal to the boundary line as the object region and a region external to the boundary line as the background region. In this case, the controller 100 recognizes regions not determined as the object and background regions, as uncertain regions.

The controller 100 senses an input signal to confirm the input boundary line to determine the object region (operation 709). That is, the controller 100 senses an input signal using the touch sensing unit 112 to determine whether a region internal to the looped curve is an object region selected by a user to perform image editing. Where the region internal to the looped curve is an object region selected to perform image editing, the controller 100 determines the region in the selected looped curve as the object region (operation 711). In contrast, where the region internal to the looped curve is not an initial object region selected to perform image editing, the controller 100 deletes the input boundary line, and the process of inputting the boundary line to the original image is performed again.

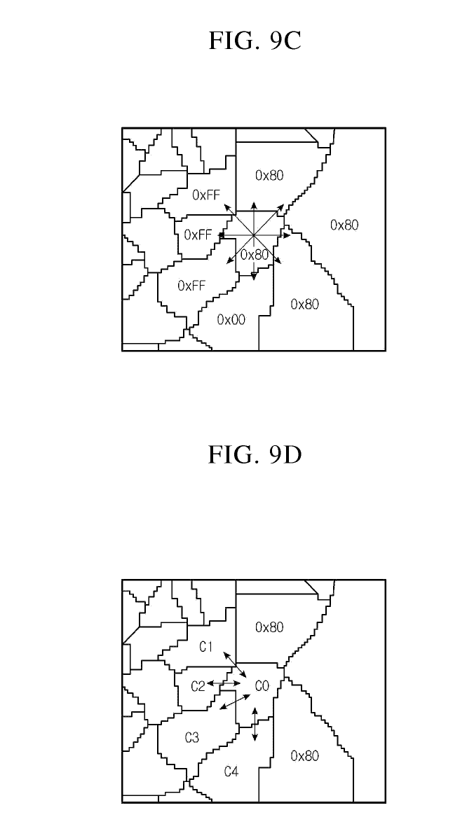

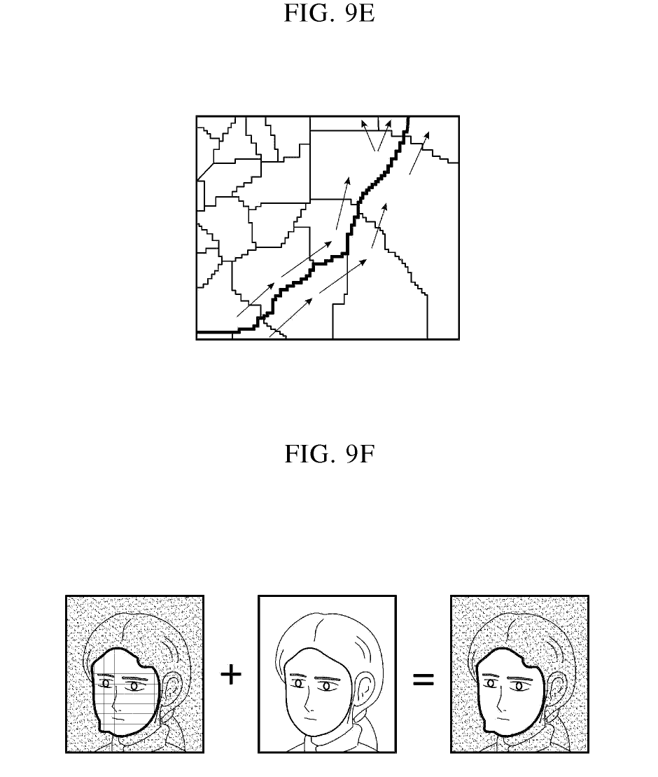

FIG. 8 illustrates an exemplary process of determining an object region, and FIGS. 9A through 9F illustrate screen examples to explain the process of determining an object region.

The controller 100 determines a last object region using the image divided into an object region (0xFF), an uncertain region (0x80), and a background region (0x00), as illustrated in FIG. 9A.

The controller 100 segments an image into unit blocks having similar colors (operation 801). Here, the image is segmented using an algorithm to segment an image using a region-based method using color similarity in a given image. In this case, the region-based method uses similarity between pixels of an image, and is suitable where a technique corresponding to a detailed boundary portion of an object in a noisy environment is not important. The controller 100 determines the object region with reference to segmentation colors. For example, the controller 100 segments the object region, uncertain region and background region of the image in unit of blocks having similar colors, as illustrated in FIG. 9B.

The controller 100 searches for uncertain blocks (operation 803). Here, the controller 100 searches to find uncertain blocks through a horizontal search corresponding to the transparency adjustment channel.

Where the uncertain block is searched, the controller 100 uses the searched uncertain block as a starting block to determine the state of the region by comparing the color between the uncertain block and the neighboring blocks (operation 805). In contrast, where the uncertain block is not searched through the horizontal search, the controller 100 continues to search to find the uncertain block.

The controller 100 stores the searched uncertain block in the storage unit 120 (operation 807). Here, the controller 100 determines a state of the uncertain block through color comparison between the stored uncertain block and neighboring blocks.

The controller 100 reads one uncertain block from the storage unit (operation 809).

The controller 100 sequentially discovers neighboring blocks in eight directions (east (E), west (W), south (S), north (N), northeast (NE), southeast (SE), southwest (SW) and northwest (NW)) of the read uncertain block and checks a determined state of the blocks to determine the object region through color comparison of the uncertain block with neighboring blocks using the read uncertain block as a starting block (operation 811). Here, the controller 100 checks states of blocks, beginning with a block close to the start point, in order to compare the block colors. For example, the controller 100 sequentially discovers neighboring blocks in eight directions of the read uncertain block, as illustrated in FIG. 9C.

The controller 100 determines whether the neighboring blocks are all in an uncertain region state (operation 813). Where the neighboring blocks are all in an uncertain region state, the controller 100 cannot determine a state of the current uncertain block and accordingly, proceeds with search to a next block. Here, the controller 100 searches to find an uncertain block among the neighboring blocks (operation 803). In contrast, where the neighboring blocks are not all in an uncertain region state, the controller 100 performs a next operation to compare colors of the uncertain block.

Where there is an object region or a background region in the neighboring blocks, the controller 100 determines a state of the current uncertain block through color comparison with the neighboring block (operation 815). In this case, the color comparison is performed by calculating a color distance between the uncertain block and the neighboring block and determining the state to be the same as the closest block. For example, the controller 100 calculates a distance between the uncertain block C0 and the neighboring blocks C1, C2, C3 and C4 and determines the state of the uncertain block to be the same as the closet block to determine a state of the uncertain block C0, as illustrated in FIG. 9D.

Where the state of the block closet to the uncertain block is an object region, the controller 100 determines the state of the block as the object region (0xFF) (operation 817). Meanwhile, where the state of the block closet to the uncertain block is a background region, the controller 100 determines the state of the uncertain block as the background region (0x00).

The controller 100 determines through search whether there is an uncertain block among the neighboring blocks (operation 819). Where there is an uncertain block, the controller 100 performs operation 807. That is, the controller 100 continues to search to find neighboring blocks and compare the color of the uncertain block with the color of the neighboring block. The controller 100 determines the object region in the image while repeatedly performing this process on the neighboring blocks. For example, the controller 100 continues to perform the process of searching to find uncertain blocks and the process of comparing the color of the uncertain block with the color of the neighboring block, as illustrated in FIG. 9E. Meanwhile, where the uncertain blocks are determined as the object region or the background region, the controller 100 determines the last object region.

The controller 100 composites a transparency adjustment channel in which the masking information of the last determined object region is stored, with the original image in operation 821, which is the process of determining the last object region. For example, the controller 100 composites the transparency channel including the masking information with the original image to determine the last object region, as illustrated in FIG. 9F.

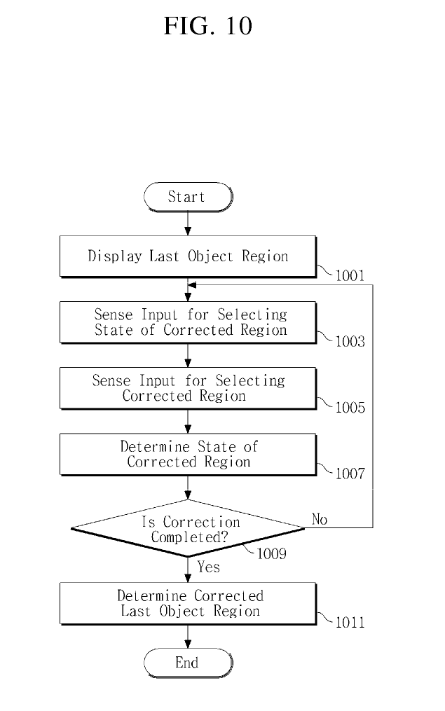

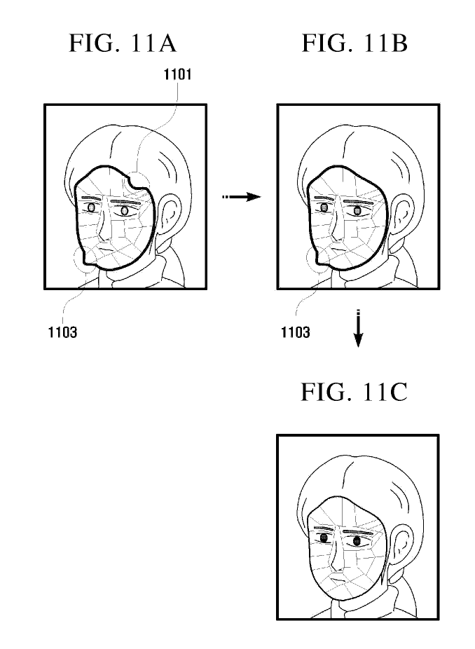

FIG. 10 illustrates an exemplary process of post-correcting an object region, and FIGS. 11A through 11V illustrate screen examples to explain the process of post-correcting an object region.

In the exemplary method, a detailed portion of the last object region may be corrected using a pixel-based correction method. In the exemplary method, a correction method to edit an image in units of a block through a touch interface is utilized.

Referring to FIGS. 10 and 11C, the controller 100 reads the image whose last object region is determined, from the storage unit 120 and controls the touch screen 110 to display the image on the display unit 114 (operation 1001).

The controller 100 selects a state of the corrected region to correct errors in the last object region (operation 1003). In this case, the state of the corrected region in which there are errors may be either the object region or the background region. Here, the controller 100 classifies a state of the region including the errors into the object region and the background region to select the state of the corrected region as one of the object region and the background region. That is, where an input signal to correct the corrected region into the object region is selected through the touch interface, the controller 100 corrects a touched corrected region into an object region. In contrast, where an input signal to correct the corrected region into the background region is selected through the touch interface, the controller 100 corrects the touched corrected region into the background region.

The controller 100 senses an input signal to select the corrected region through the touch interface (operation 1005). That is, the controller 100 recognizes a motion of the user's finger tip on the last object region through the touch sensing unit 112 and senses the selection of the corrected portion.

Where an error region selection in the last object region is sensed, the controller 100 determines a state of the selected region according to a previously set state of the corrected region (operation 1007). For example, as illustrated in FIG. 11A, the controller 100 senses an input to correct an error 1101 of a head portion. That is, the controller 100 corrects an error 1101 of the head portion into an object region. In this case, the controller 100 controls to display the object region including an error 1101 of the head portion region, which is determined as the object region, on the display unit 114, as illustrated in FIG. 11B.

The controller 100 senses an input signal indicating that there is a block to be additionally corrected (operation 1009). That is, the controller 100 senses an input signal indicating that there is a block to be additionally corrected in the object region. Where the input signal indicating that there is a block to be additionally corrected is sensed, the controller 100 performs a process of selecting the state of the corrected region (operation 1003). For example, as illustrated in FIG. 11B, the controller 100 senses an input to correct a jaw portion error 1103, which is an error in the object region. In this case, the controller 100 additionally corrects the jaw portion error 1103. Here, the controller 100 determines the region including the jaw portion error 1103 as the background region. In this case, the controller 100 deletes the jaw portion error and controls to display the result of deleting on the display unit 114, as illustrated in FIG. 11C. On the other hand, where an input indicating there is no block to be additionally corrected is sensed, the controller 100 determines the corrected object region as the last object region.

The controller 100 determines the corrected object region as the last object region (operation 1011). Where a boundary of the last corrected object region of the image is unclear, the controller 100 represents the boundary as a clear curve through an application program. Here, where a desired object region in the original image is designated, the controller 100 clearly composites the designated region. For example, the controller 100 uses an application program corresponding to a clear joint between the original image and the object image and clear representation of a discontinuous boundary line.

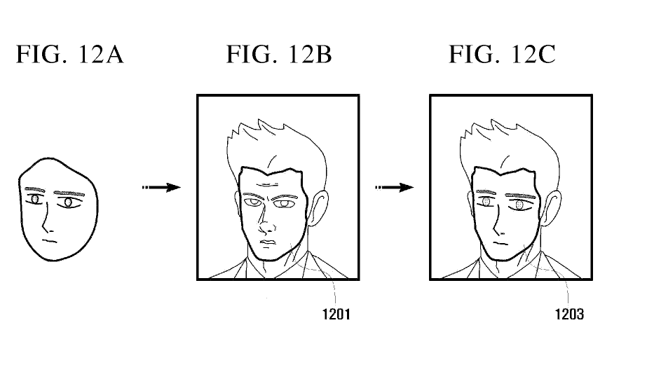

FIGS. 12A through 12C illustrate screen examples in which the image editing and composition are applied.

Referring to FIGS. 12A through 12C, in one example, the controller 100 enables the last object region to be edited in and composited with another image. For example, the controller 100 may edit an obtained last object region a in a region 1201 of another image b. Here, the controller 100 may obtain the last object region a by using copy and composite it with another image by using paste. In this case, the controller 100 may control to display the region 1203 of the edited image C on the display unit 114.

Here, the controller 100 may read one of previously stored image data, as another image, from the storage unit 120, and edit and composite the image using the determined last object region. The controller 100 may receive image data for image editing from another mobile device.

According to example(s) described above, a user of a mobile device may easily select a desired object region through a simple touch operation.

Furthermore, user convenience can be maximized through image editing and composition on a touch device having a touch interface.

The methods described above may be recorded, stored, or fixed in one or more computer-readable media that includes program instructions to be implemented by a computer to cause a processor to execute or perform the program instructions. The media may also include, alone or in combination with the program instructions, data files, data structures, and the like. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of editing an image in a mobile device, the method comprising:
dividing the image into an uncertain region, an object region, and a background region along a boundary line which is input through a touch interface and displayed on the image; and
determining a last object region by determining the uncertain region as one of the object region and the background region through color comparison of the uncertain region with neighboring blocks.

2. The method of claim 1, wherein the dividing of the image comprises displaying the boundary line using a translucent looped curve having a predetermined thickness.

3. The method of claim 1, wherein the dividing of the image comprises masking a transparency adjustment channel on the image to display the uncertain region as a translucent region, the object region as a transparent region, and the background region as an opaque region.

4. The method of claim 1, wherein the determining of the last object region comprises:
segmenting the image into unit blocks having significantly identical colors, and searching to find the uncertain region of the image; and
sequentially searching to find neighboring blocks in eight directions of the uncertain region, and determining a state of the uncertain region by comparing a color of the neighboring block with a color of the uncertain region.

5. The method of claim 1, further comprising:
after the determining of the last object region, post-correcting an error included in the last object region.

6. The method of claim 5, wherein the post-correcting of the error comprises adding or deleting a block selected through the touch interface to or from the object region.

7. The method of claim 1, further comprising:
editing the last object region by compositing the last object region with another image.

8. An apparatus to edit an image in a mobile device, the apparatus comprising:
a touch screen to sense a boundary line input to an image through a touch interface and to display the boundary line; and
a controller to divide the image into an uncertain region, an object region, and a background region along the boundary line and to determine a last object region by determining the uncertain region as one of the object region and the background region through color comparison of the uncertain region with neighboring blocks.

9. The apparatus of claim 8, wherein the touch screen further comprises:
a touch sensing unit to adjust a sensitivity of the touch interface to input the boundary line; and
a display unit to display the boundary line using a translucent looped curve having a predetermined thickness.

10. The apparatus of claim 8, wherein the controller masks a transparency adjustment channel on the image to display the uncertain region as a translucent region, the object region as a transparent region, and the background region as an opaque region.

11. The apparatus of claim 8, wherein the controller segments the image into unit blocks having significantly identical colors, and searches to find the uncertain region of the image.

12. The apparatus of claim 8, wherein the controller sequentially searches to find neighboring blocks in eight directions of the uncertain region, and determines a state of the uncertain region by comparing a color of the neighboring block with a color of the uncertain region.

13. The apparatus of claim 8, wherein the controller post-corrects an error included in the last object region.

14. The apparatus of claim 8, wherein the controller adds or deletes a block selected through the touch interface to or from the object region.

15. The apparatus of claim 8, wherein the controller edits the last object region by compositing the last object region with another image.
